(19) United States
(12) Patent Application Publication
(10) Pub. No.: US 2020/0132440 A1
(43) Pub. Date: Apr. 30, 2020

(54) LIGHT PROJECTION CALIBRATION DEVICE FOR DETERMINING WHETHER LIGHT EMISSION ELEMENT AND OPTICAL ELEMENT ARE ALIGNED TO ACCEPTABLE LEVEL

(71) Applicant: HIMAX TECHNOLOGIES LIMITED, Tainan City (TW)

(72) Inventors: Yi-Nung Liu, Tainan City (TW); Cheng-Hung Chi, Tainan City (TW); Ming-Shu Hsiao, Tainan City (TW)

(21) Appl. No.: 16/172,869

(22) Filed: Oct. 29, 2018

(51) Int. Cl. G01B 11/25; G02B 27/30; G02B 27/09; G01J 1/42; G03B 21/20

(52) U.S. Cl. CPC G01B 11/2504; G02B 27/30; G03B 21/204; G01J 1/4257; G02B 27/0944

(57) ABSTRACT

A light projection calibration device includes a light emission element and an optical element. The light emission element is used to emit light and includes a plurality of light emission points. The plurality of light emission points are used to emit the light and orderly arranged to form a predetermined pattern. The optical element is disposed according to position of the light emission element and used to diffract the light to generate diffracted light. The diffracted light is projected to a far field plane to generate a plurality of fan-out points on the far field plane. The fan-out points are analyzed to obtain a light intensity waveform used to determine whether the light emission element and the optical element are aligned to an acceptable level.

### BACKGROUND OF THE INVENTION

### 1. Field of the Invention

The invention relates to a light projection calibration device, and more particularly, a light projection calibration device used to determine whether a light emission element and an optical element are aligned to an acceptable level.

### 2. Description of the Prior Art

In the field of three dimensional detection, a solution is to emit light points which are diffracted via an optical element to a surface of a detected object (e.g. a user's face), and then observe the distribution of the light points on the detected object to build a three dimensional model of the surface of the object. For this purpose, a light emission element and the abovementioned optical element have to be overlapped to generate the light points. However, it is a challenge to accurately align a light emission element and a corresponding optical element. When assembling a light emission element and an optical element, the light emission element and the optical element can be placed on an auxiliary frame tool to try to have both elements roughly aligned. However, it is difficult to reduce the error in alignment to an acceptable level. If the light emission element and the optical element are not properly aligned, the quality of subsequent three dimensional detection is deteriorated.

### SUMMARY OF THE INVENTION

An embodiment provides a light projection calibration device including a light emission element and an optical element. The light emission element is used to emit light and includes a plurality of light emission points. The plurality of light emission points are used to emit the light and orderly arranged to form a predetermined pattern. The optical element is disposed according to position of the light emission element and used to diffract the light to generate diffracted light. The diffracted light is projected to a far field plane to generate a plurality of fan-out points on the far field plane. The fan-out points are analyzed to obtain a light intensity waveform used to determine whether the light emission element and the optical element are aligned to an acceptable level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a light projection calibration device according to an embodiment.

FIG. 2 illustrates a top view of the light emission element in FIG. 1.

FIG. 3 illustrates fan-out points and diffracted patterns projected on the far field plane in FIG. 1 where the light emission element and the optical element are aligned to an acceptable level.

FIG. 4 illustrates fan-out points and diffracted patterns projected on the far field plane in FIG. 1 where the light emission element and the optical element are misaligned.

FIG. 5 illustrates fan-out points and diffracted patterns projected on the far field plane in FIG. 1 where a diffracted pattern in FIG. 5 may have twice the size of a diffracted pattern in FIG. 3 or FIG. 4.

FIG. 6 illustrates a light intensity waveform diagram corresponding to the diffracted light of FIG. 1.

FIG. 7 illustrates a light projection calibration device according to an embodiment.

FIGS. 8-9 illustrate the light emission element may further include a plurality of second light emission points.

FIGS. 10-11 illustrate that a plurality of second fan-out points may be further projected on the far field plane of FIG. 1 according to embodiments.

### DETAILED DESCRIPTION

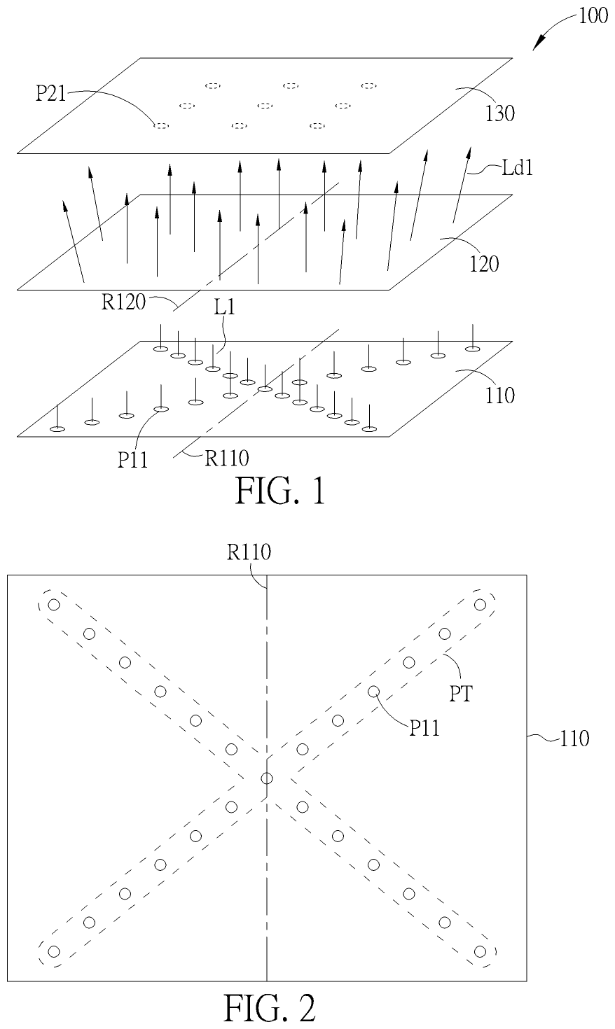

FIG. 1 illustrates a light projection calibration device 100 according to an embodiment. The light projection calibration device 100 may include a light emission element 110, an optical element 120 and a far field plane 130. The light emission element 110 may be used to emit at least first light L1 and include a plurality of first light emission points P11. The light emission points P11 may be used to emit the first light L1 and be orderly arranged to form a predetermined pattern PT. The optical element 120 may be disposed according to the position of the light emission element 110 and be used to diffract at least the first light L1 to generate diffracted light Ldl. The diffracted light Ldl may be projected to the far field plane 130 to generate at least a plurality of fan-out points P21 on the far field plane 130. The fan-out points P21 may be analyzed to obtain a light intensity waveform (described below). The light intensity waveform may be used to determine whether the light emission element 110 and the optical element 120 are aligned to an acceptable level. In another embodiment, a collimator, such as collimating lens, may be optionally disposed between the light emission element 110 and the optical element 120 to collimate the at least first light L1.

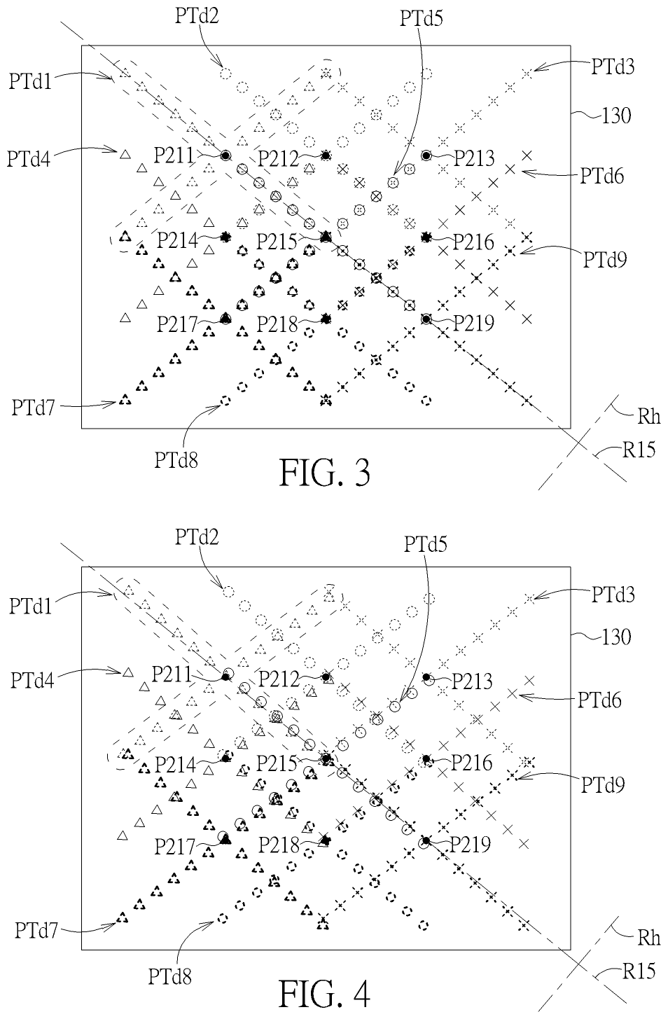

FIG. 2 illustrates a top view of the light emission element 110 in FIG. 1. FIG. 3 illustrates fan-out points and diffracted patterns projected on the far field plane 130 in FIG. 1 where the light emission element 110 and the optical element 120 are aligned to the acceptable level. FIG. 4 illustrates fan-out points and diffracted patterns projected on the far field plane 130 in FIG. 1 where the light emission element 110 and the optical element 120 are misaligned.

The light emission element 110 may include a vertical cavity surface emitting laser (VCSEL) emitter, and the first light L1 may be laser. The optical element 120 may include a diffraction optical element (DOE). The far field plane 130 may be designed for the fan-out points P21 to be observed and sensed more easily and accurately.

As shown in FIG. 2, the predetermined pattern PT formed by the light emission points P11 may be a cross pattern like an “X” sign. The cross pattern in FIG. 2 is merely an example, and the predetermined pattern PT may be another pattern according to another embodiment. As shown in FIG. 1 and FIG. 3, the first light L1 may be diffracted through the optical element 120 to generate the diffracted light Ldl, and the diffracted light Ldl may be projected on the far filed plane 130 to form n corresponding first fan-out points where n is a positive integer. As an example, in FIG. 3, the number n may be 9. Regarding the n first fan-out points P21, a 1^{st} first fan-out point P21 may be denoted as P211, a 2^{nd} first fan-out point P21 may be denoted as P212, and so on.

According to an embodiment, the predetermined pattern PT formed by the light emission points P11 may include at least a segment. According to another embodiment, the predetermined pattern PT may include a cross pattern formed by two segments.

For example, as shown in FIG. 2, 25 first light emission points P11 of the light emission element 110 may emit the first light L1 to form the predetermined pattern PT which is a cross pattern. As shown in FIG. 3, 9 first fan-out points P21 and 9 corresponding diffracted patterns are formed with the diffracted light Ldl. The numbers of the first fan-out points P21 and the light emission points P11 shown in FIGS. 1-4 are merely of an example instead of limiting the scope of embodiments.

According to an embodiment, a portion of the diffracted light Ldl corresponding to one of the first fan-out points P21 may form a corresponding diffracted pattern. For example, a first portion of the diffracted light Ldl corresponding to one fan-out point (e.g. P211) of the plurality of first fan-out points P21 may forms a first diffracted pattern (e.g. PTd1), and a second portion of the diffracted light Ldl corresponding to another one fan-out point (e.g. P219) of the plurality of first fan-out points P21 may form a second diffracted pattern (e.g. PTd9). Likewise, different portions of the diffracted light Ldl corresponding to the first fan-out points P212 to P218 may respectively form diffracted patterns PTd2 to PTd8.

Regarding the 1^{st} first fan-out point P211 shown in FIG. 3, the predetermined pattern PT formed by the first light L1 may be diffracted through the optical element 120 to generate the 1^{st} first fan-out point P211 and the corresponding 1^{st} diffracted pattern PTd1 on the far field plane 130. As shown in FIG. 3, the 1^{st} diffracted pattern PTd1 may be formed by 25 light points which are generated by the 1^{st} portion of the diffracted light Ldl and corresponding to the 25 first light emission points P11 in FIG. 2. As shown in FIG. 3, each diffracted pattern may be formed by a set of diffracted light points corresponding to the light emission points in FIGS. 1-2.

Likewise, a 2^{nd} portion to a 9^{th} portion of the diffracted light Ldl may respectively generate a 2^{nd} diffracted pattern PTd2 to a 9^{th} diffracted pattern PTd9, where each diffracted pattern may be formed by 25 diffracted light points. In FIG. 3, diffracted light points corresponding to different fan-out points may be expressed with different signs for distinction and explanation instead of showing real diffracted light points.

As shown in FIGS. 1-3, when the light emission element 110 and the optical element 120 are aligned to the acceptable level, a jₜₕ diffracted pattern PTdj formed by a jₜₕ portion of the diffracted light Ldl corresponding to a jₜₕ first fan-out point P21j may substantially align with a kₜₕ diffracted pattern PTdk formed by a kₜₕ portion of the diffracted light Ldl corresponding to a kₜₕ first fan-out point P21k, wherein the jₜₕ first fan-out point P21j and the kₜₕ first fan-out point P21k may be of then first fan-out points P21, j and k are positive integers, 0<j<(n+1), and 0<k<(n+1).

As shown in FIGS. 2-3, the light emission element 110 may correspond to a virtual reference line R110, and the optical element 120 may correspond to a virtual reference line R120 (shown in FIG. 1). When the virtual reference lines R110-R120 are substantially in parallel or form an angle smaller than a threshold, the light emission element 110 and the optical element 120 may be aligned to the acceptable level. For example, as shown in FIG. 3, the mentioned variables j and k may respectively be 1 and 5. When the light emission element 110 and the optical element 120 are aligned to the acceptable level, the 1^{st} diffracted pattern PTd1 may substantially align with a 5ₜₕ diffracted pattern PTd5. In other words, a portion of the 1^{st} diffracted pattern PTd1 and a portion of the 5^{th} diffracted pattern PTd5 may be both on a reference line R15. Likewise, when the light emission element 110 and the optical element 120 are aligned to the acceptable level, a 9^{th} diffracted pattern PTd9 corresponding to the 9^{th} first fan-out point P219 may align with the 5ₜₕ diffracted pattern PTd5, the 2^{nd} diffracted pattern PTd2 corresponding to the 2^{nd} first fan-out point P212 may align with a 6^{th} diffracted pattern PTd6 corresponding to the 6^{th} first fan-out point P216, and so on.

As shown in FIG. 4, when the light emission element 110 and the optical element 120 are misaligned, a pₜₕ diffracted pattern PTdp formed by a pₜₕ portion of the diffracted light Ldl corresponding to a pₜₕ first fan-out point P21p may substantially fail to align with a qₜₕ diffracted pattern PTdq formed by a qₜₕ portion of the diffracted light Ldl corresponding to a qₜₕ first fan-out point P21q, where the pₜₕ first fan-out point P21p and the qₜₕ first fan-out point P21q may be of the n first fan-out points P21, p and q are positive integers, 0<p<(n+1), and 0<q<(n+1). When the virtual reference lines R110-R120 fail to be substantially in parallel, or fail to form an angle smaller than the threshold, the light emission element 110 and the optical element 120 may be misaligned.

According to an embodiment, the mentioned jₜₕ first fan-out point P21j may be adjacent to the k^{th} first fan-out point P21k, and the mentioned p^{th} first fan-out point P21p may be adjacent to the q^{th} first fan-out point P21q. For example, if the predetermined pattern PT is a cross pattern like a “+” sign formed by a vertical segment and a horizontal segment, the jₜₕ first fan-out point P21j may be adjacent to the k^{th} first fan-out point P21k, and the mentioned p^{th} first fan-out point P21p may be adjacent to the q^{th} first fan-out point P21q.

Because the first light emission points P11 may be used to calibrate the assembly of the light emission element 110 and the optical element 120, the first light emission points P11 may be anchor points.

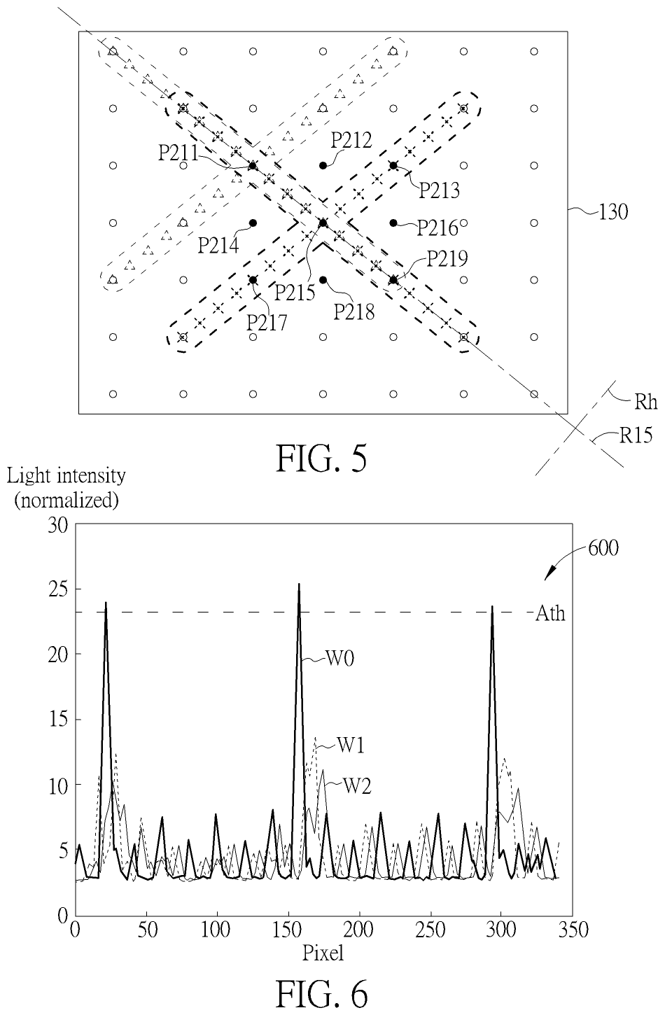

FIG. 5 illustrates fan-out points and diffracted patterns projected on the far field plane 130 where the light emission element 110 and the optical element 120 are aligned to the acceptable level according to another embodiment. As shown in FIG. 5, a diffracted pattern of FIG. 5 may have twice the size of a diffracted pattern of FIG. 3 or FIG. 4. Like FIG. 3 and FIG. 4, even a diffracted pattern is set to have a doubled size, two diffracted patterns may be aligned with one another when the light emission element 110 and the optical element 120 are aligned to the acceptable level, and two diffracted patterns may be misaligned with one another when the light emission element 110 and the optical element 120 are misaligned.

FIG. 6 illustrates a light intensity waveform diagram 600 corresponding to the diffracted light Ldl in FIG. 1. A light intensity waveform W0 in FIG. 6 may be corresponding to the diffracted patterns in FIG. 3. A light intensity waveform W1 in FIG. 6 may be corresponding to the diffracted patterns in FIG. 4. A light intensity waveform W2 in FIG. 6 may be corresponding to the diffracted patterns (not shown in figures) generated when the light emission element 110 and the optical element 120 are more misaligned than in FIG. 4. The light intensity waveforms W0-W2 may be obtained by analyzing the diffracted light Ldl in FIG. 1. For example, if the virtual reference lines R110 and R120 may form an angle when the light emission element 110 and the optical element 120 are assembled, the angle may substantially be zero degrees to generate the waveform W0, the angle may substantially be one degree to generate the waveform W1, and the angle may substantially be two degrees to generate the waveform W2.

For example, regarding FIG. 3 and the light intensity waveform W0, when the diffracted light Ldl forms the diffracted patterns (e.g. PTd1-PTd9) in FIG. 3, and the diffracted patterns in FIG. 3 may be aligned to forma clear mesh pattern because the light emission element 110 and the optical element 120 are aligned to the acceptable level. By accumulating light intensity of the diffracted patterns by referring to a reference axis Rh, the light intensity waveform W0 may be generated to have periodical peaks formed by a plurality of diffracted light points arranged in a line. The reference axis Rh may be orthogonal to the abovementioned reference line R15.

Regarding FIG. 4 and the light intensity waveform W1, the diffracted patterns in FIG. 4 may be misaligned to form a less clear mesh pattern because the light emission element 110 and the optical element 120 are misaligned. However, by accumulating light intensity of the diffracted patterns by referring to the reference axis Rh, it may still be observed that light intensity may be higher periodically in some ranges of the reference axis Rh. This is because of that the diffracted patterns in FIG. 4 may still form a loose and indistinct mesh pattern. Regarding the light intensity waveform. W2, it may be more difficult to observe periodical peaks because the corresponding diffracted patterns are more misaligned.

Hence, it may be determined the light emission element 110 and the optical element 120 are aligned to the acceptable level when the light intensity waveform reaches a predetermined amplitude Ath. In other words, when the light intensity wave fails to reach the predetermined amplitude Ath, it may be determined that the light emission element 110 and the optical element 120 are misaligned. For example, the waveforms W1 and W2 in FIG. 5 may be observed to determine that the light emission element 110 and the optical element 120 are misaligned. In FIG. 6, the vertical axis may correspond to the reference line R15 and light intensity with a unit calculated by normalizing light intensity, and the horizontal axis may correspond to the reference axis Rh with a spatial unit (such as pixel or length unit) or a related normalized unit. In FIG. 6, the unit of the horizontal axis may be pixel as an example.

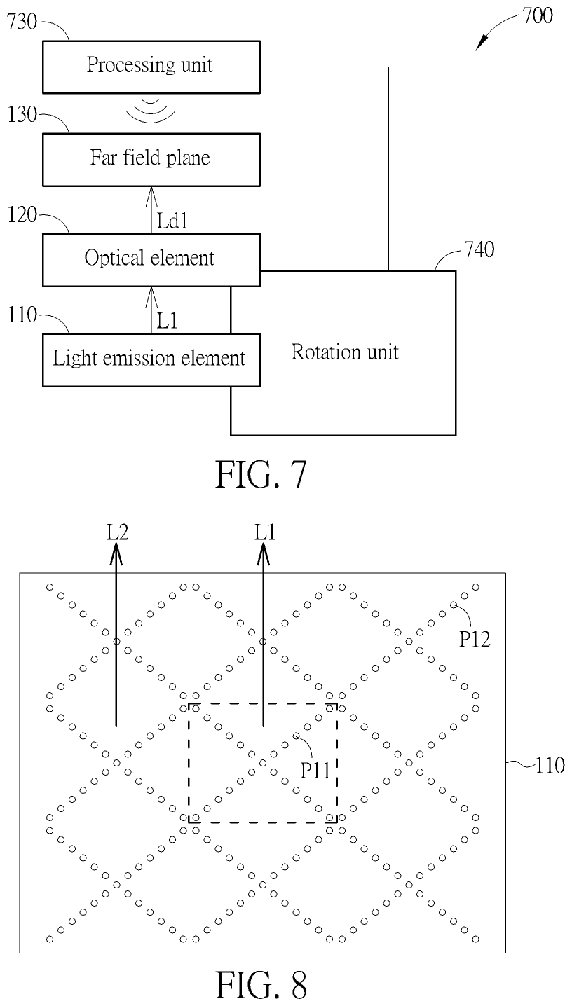

FIG. 7 illustrates a light projection calibration device 700 according to an embodiment. The light projection calibration device 700 may include the light emission element 110, the optical element 120, the far field plane 130, a processing unit 730 and a rotation unit 740. The light emission element 110 and the optical element 120 have been described above, so it is not repeatedly described. The processing unit 730 may be used to sense the diffracted light Ldl projected on the far field plane 130, generate the light intensity waveform (e.g. the waveforms W0 to W2 in FIG. 6), analyze the light intensity waveform, and determine whether the light emission element 110 and the optical element 120 are aligned to the acceptable level. According to an embodiment, the processing unit 730 may determine the light emission element and the optical element are aligned to the acceptable level when the light intensity waveform reaches a predetermined amplitude. The processing unit 730 may include an image sensor and a processor according to an embodiment. The image sensor may sense the first fan-out points P21 distributed on the far field plane 130 to generate sensing data. The processor may be coupled to the image sensor and process the sensing data to generate and analyze light intensity waveform accordingly and determine whether the light emission element 110 and the optical element 120 are aligned to the acceptable level. The rotation unit 740 may be coupled to the processing unit 730 and be controlled according to the processing unit 730. When the processing unit 730 determines the light emission element 110 and the optical element 120 are misaligned, the rotation unit 740 may be used to rotate the light emission element 110 and/or the optical element 120 till the light emission element 110 and the optical element 120 are aligned to the acceptable level. For example, the rotation unit 740 may gradually rotate at least one of the light emission element 110 and the optical element 120 while the processing unit 730 generates the light intensity waveform and monitors the amplitude of the waveform, and the rotation unit 740 may stop rotating any of the light emission element 110 and the optical element 120 when the processing unit 730 determines that the light emission element 110 and the optical element 120 are aligned to the acceptable level. According to an embodiment, the rotation unit 740 may include a motor such as a step motor to rotate the light emission element 110 and/or the optical element 120 one step at a time to finely adjust the alignment of the light emission element 110 and the optical element 120.

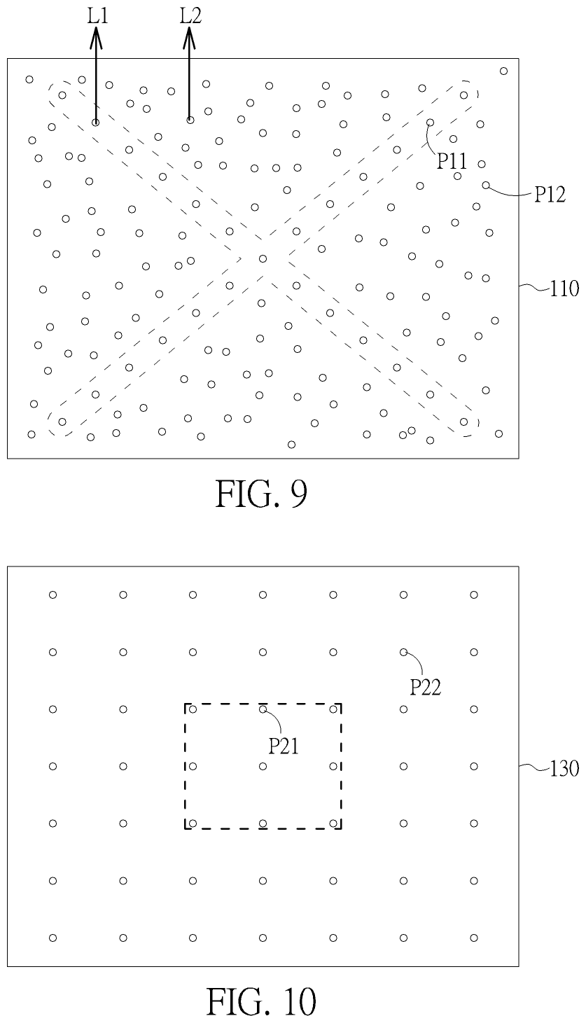

FIGS. 8-9 illustrate the light emission element 110 may further include a plurality of second light emission points P12 according to embodiments. The second light emission points P12 may be used to emit second light L2. As shown in FIG. 8, the second light emission points P12 may be orderly arranged with the first light emission points P11. As shown in FIG. 9, the second light emission points P12 may be randomly arranged. The first light emission points P11 may be on an appropriate area of the light emission element 110. For example, a substantially central area of the light emission element 110 may be feasible; however, another area may be useful according to experimental results or design concerns.

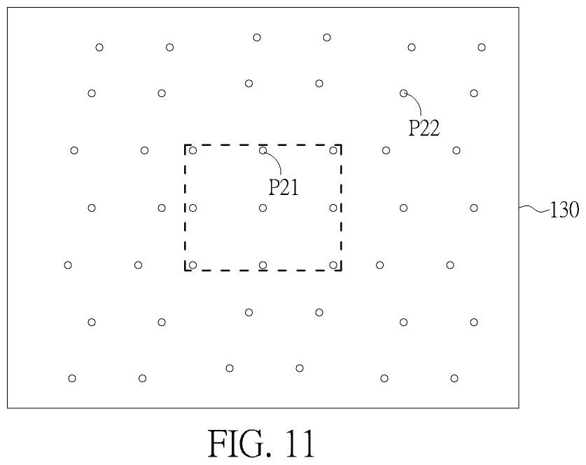

FIGS. 10-11 illustrate that a plurality of second fan-out points P22 may be further projected on the far field plane 130 according to embodiments. As shown in FIG. 10, the first fan-out points P21 may be orderly arranged, and the second fan-out points P22 may be orderly arranged with the first fan-out points P21. As shown in FIG. 11, the first fan-out points are orderly arranged, and the second fan-out points are randomly arranged. According to embodiments, randomly arranged fan-out points may increase the accuracy of three dimensional detection in some cases.

According to experiments, the solution provided by an embodiment may be feasible to determine whether the optical element and the light emission element are aligned to an acceptable level when any of the following conditions occurs. The conditions include wavelength shift of light, z (up-down) direction shift of an element, tilt of an element, x (right-left) direction shift of an element, y (forward-backward) direction shift of an element, variation of process pitch, and a mismatched size of a light emission element. In other words, the abovementioned solution may be reliable against the process inaccuracy.

In summary, by observing light intensity waveform obtained from analyzing diffracted patterns formed by diffracted light points generated by an optical element and an light emission element, it may be determined whether the optical element and the light emission element are aligned to an acceptable level, and their misalignment may be accordingly eliminated. Hence, a solution for improving assembly of light projection calibration device is realized.

Those skilled in the art will readily observe that numerous modifications and alterations of the device and method may be made while retaining the teachings of the invention. Accordingly, the above disclosure should be construed as limited only by the metes and bounds of the appended claims.

1. A light projection calibration device, comprising:
a light emission element configured to emit at least first light and comprising:
a plurality of first light emission points configured to emit the first light and orderly arranged to form a predetermined pattern; and
an optical element disposed according to position of the light emission element and configured to diffract at least the first light to generate diffracted light;
wherein the diffracted light is projected to a far field plane to generate at least a plurality of first fan-out points on the far field plane, the plurality of first fan-out points are analyzed to obtain a light intensity waveform used to determine whether the light emission element and the optical element are aligned to an acceptable level, a first portion of the diffracted light corresponding to one fan-out point of the plurality of first fan-out points forms a first diffracted pattern, a second portion of the diffracted light corresponding to another fan-out point of the plurality of first fan-out points forms a second diffracted pattern, the first diffracted pattern and the second diffracted pattern are generated according to the predetermined pattern, and when the light emission element and the optical element are aligned to the acceptable level, the first diffracted pattern substantially aligns with the second diffracted pattern.

2. The light projection calibration device of claim 1, further comprising:
a processing unit configured to sense the plurality of first fan-out points projected on the far field plane, generate the light intensity waveform, analyze the light intensity waveform, and determine whether the light emission element and the optical element are aligned to the acceptable level.

3. The light projection calibration device of claim 2, wherein the processing unit comprises:
an image sensor configured to sense the plurality of first fan-out points distributed on the far field plane to generate sensing data; and
a processor coupled to the image sensor and configured to process the sensing data, generate and analyze light intensity waveform accordingly, and determine whether the light emission element and the optical element are aligned to the acceptable level.

4. The light projection calibration device of claim 2, wherein the processing unit determines the light emission element and the optical element are aligned to the acceptable level when the light intensity waveform reaches a predetermined amplitude.

5. The light projection calibration device of claim 2, further comprising:
a rotation unit configured to rotate the light emission element and/or the optical element till the light emission element and the optical element are aligned to the acceptable level.

6. The light projection calibration device of claim 5,
wherein the rotation unit comprises a step motor to rotate the rotate the light emission element and/or the optical element one step at a time.

7. The light projection calibration device of claim 1, wherein a collimator is disposed between the light emission element and the optical element.

8. The light projection calibration device of claim 1, wherein the predetermined pattern comprises at least a segment.

9. The light projection calibration device of claim 1, wherein the predetermined pattern comprises a cross pattern formed by two segments.

10-11. (canceled)

12. The light projection calibration device of claim 1, wherein the diffracted light is projected to the far field plane to further generate a plurality of second fan-out points.

13. The light projection calibration device of claim 12, wherein the plurality of first fan-out points are orderly arranged, and the plurality of second fan-out points are orderly or randomly arranged with the plurality of first fan-out points.

14. The light projection calibration device of claim 1, wherein the light emission element further comprises a plurality of second light emission points configured to emit second light.

15. The light projection calibration device of claim 14, wherein the plurality of second light emission points are orderly or randomly arranged with the plurality of first light emission points.
